(19) United States
(12) Patent Application Publication
(10) Pub. No.: US 2004/0036276 A1
(43) Pub. Date: Feb. 26, 2004

(54) Air-conditioning duct system

(76) Inventors: Esko Hiden, Turku (FI); Erkki Salmio, Littoinen (FI)

Correspondence Address: NIXON & VANDERHYE, PC, 1100 N GLEBE ROAD, 8TH FLOOR, ARLINGTON, VA, 22201-4714, US

(21) Appl. No.: 10/257,250

(22) PCT Filed: Apr. 9, 2001
(86) PCT No.: PCT/FI01/00349

(30) Foreign Application Priority Data
Apr. 12, 2000 (FI) 20000875

(51) Int. Cl. F16L 3/00

(52) U.S. Cl. 285/123.15

(57) ABSTRACT

The invention relates to an air-conditioning duct system comprising ducts (1) which comprise a first inner casing (3) and a first outer casing (4) and a first insulator (5) between them, and connecting pieces (2) joining the ducts (1), the connecting pieces comprising a second inner casing (6) and a second outer casing (7) and a second insulator (8) between them. The first insulator (5) in the ducts (1) is an insulating material, and the second insulator (8) in the connecting piece (2) is insulating air.

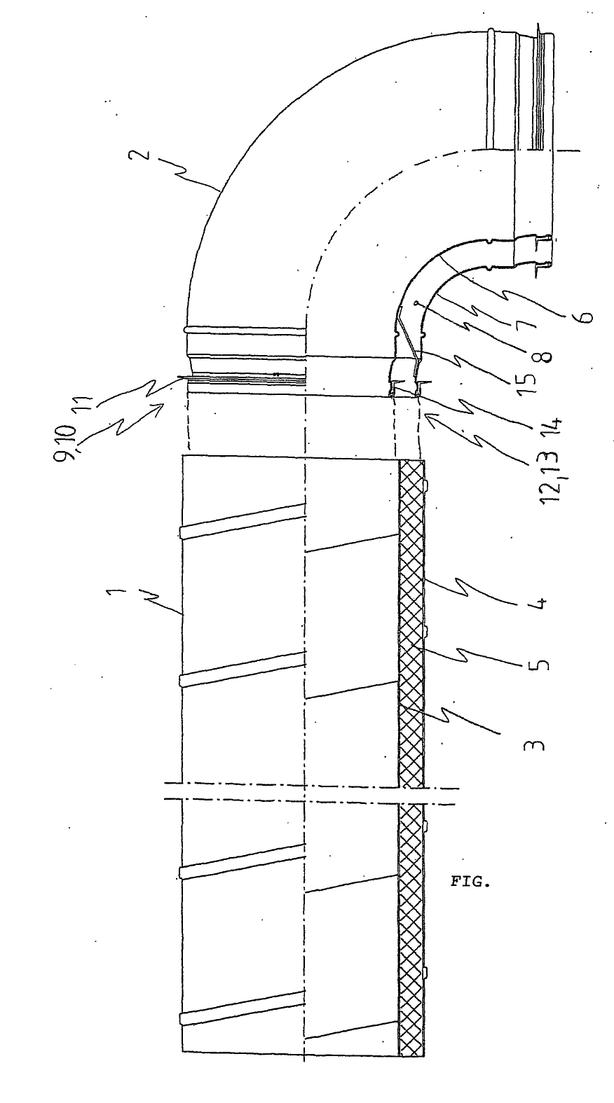

### BACKGROUND OF THE INVENTION

The invention relates to an air-conditioning duct system comprising ducts which comprise a first inner casing and a first outer casing and a first insulator between them, and connecting pieces joining the ducts, the connecting pieces comprising a second inner casing and a second outer casing and a second insulator between them.

Thermal conductivity of air is considerably lower than that of an insulating material, which means that air is a better thermal insulator than any insulating material.

An air-conditioning duct system according to the preamble of claim 1 is known from the Finnish published specification No. 40760.

This Finnish published specification discloses an air-conditioning duct system comprising a duct which is made up of two separate, thin-walled sheet-iron pipes arranged coaxially between two connecting parts, such as angled ducts, pipe tees or the like, in other words, an outer pipe and an inner pipe having only an insulating air space between them. The outer pipe and the inner pipe are attached to each other only by means of the external insulation surrounding the connecting parts in such a manner that during installation, the inner pipe is pushed inside said insulation and the outer pipe on top of it.

A problem with the arrangement described above is that it is difficult to install the ducts so that they remain at a certain distance from each other. This applies especially to long ducts.

### BRIEF DESCRIPTION OF THE INVENTION

It is thus an object of the invention to develop an air-conditioning duct system, in which the above problem is solved.

The object of the invention is achieved by an air-conditioning duct system which is characterized in that the first insulator in the ducts is an insulating material and that the second insulator in the connecting piece is insulating air.

Preferred embodiments of the invention are set forth in the dependent claims.

The air duct system of the invention, which comprises ducts and connecting parts (curves, tees, transforming parts, etc.), thus has an insulating solution in which there is an insulating material between the outer casing and the inner casing of the duct, but only air is used as insulation between the outer casing and the inner casing of the connecting parts.

The solution of the invention provides the advantage that the outer casing and the inner casing of the duct remain better at a specific distance from each other, since an insulating material is used in the duct.

The solution of the invention provides the further advantage that the duct can be cut at any location, because the insulating material supports the outer casing and the inner casing everywhere.

The solution of the invention provides the yet further advantage that the insulating material prevents air from moving between the outer casing and the inner casing especially in a vertical duct, which might cause convection between the outer casing and the inner casing when air moves upwards. In the connecting parts, the uninsulated space is so limited that an actual air movement does not occur.

An identical sealing system, for instance sealing rings, is preferably used in the joints of the duct and connecting pieces in both the outer casing and the inner casing. A sealing on the inner casing and the outer casing makes the product tighter than when only one casing has a sealing, as is the case in the solution known from the Finnish published specification No. 40760. This type of ducts are generally used in transporting underheated air, in which case there is a danger that condensate is created on the outer surface of the outer duct, if the temperature difference and air humidity are favourable and cold air comes into contact with the outer casing. When both the outer casing and the inner casing has a sealing, the joint is sealed better and there is no danger of condensate.

The fastening of the sealing ring at the end of the connecting part can be made round, in which case the connecting part is easier to install inside the duct, since the ends of the outer casing and the inner casing are rounded.

Further, the solution of the invention provides the advantage that leaving the insulating material out of the connecting parts reduces the manufacturing costs.

### BRIEF DESCRIPTION OF THE FIGURES

In the following the invention will be described in greater detail by means of preferred embodiments and with reference to the accompanying FIGURE which shows a partial cross-section of a disassembled joint between the connecting part and the duct.

### DETAILED DESCRIPTION OF THE INVENTION

The FIGURE shows a part of an air-conditioning duct system which comprises ducts 1 and connecting pieces 2 joining them. The FIGURE shows a substantially straight duct 1 and a connecting piece 2 producing a 90° angle. The duct 1 can also have another shape. The duct 1 can be partly or completely curved, for instance. The duct 1 can have any shape in cross-section, it can be round, oval, oblong or a combination of the above-mentioned shapes.

The connecting piece 2 can be a curve, tee, transforming part, etc. The connecting part 2 can have any shape in cross-section, it can be round, oval, oblong or a combination of the above-mentioned shapes.

The duct 1 and the connecting piece 2 preferably have an at least partly same-sized and -shaped cross-section so as to allow an easy connection.

The duct 1 comprises a first inner casing 3 and a first outer casing 4. A first insulator 5 is located between the first inner casing 3 and the first outer casing 4. The first insulator 5 is mineral wool, for instance.

The connecting piece 2 comprises a second inner casing 6 and a second outer casing 7. A second insulator 8 is located between the second inner casing 6 and the second outer casing 7.

The first inner casing 3 and the first outer casing 4 of the duct 1 and the second inner casing 6 and the second outer casing 7 of the connecting piece 2 are for example, but not necessarily, made of steel iron.

In the solution of the invention, the first insulator 5 in the ducts 1 is an insulating material and the second insulator 8 in the connecting piece 2 is insulating air.

The second outer casing 7 of the connecting piece 2 preferably comprises first sealing elements 9 which are adapted to function together with the first outer casing 4 of the duct 1.

In the FIGURE, the second outer casing 7 of the connecting piece 2 comprises a first joint end 10 which is adapted to be pushed partly into the duct 1. The first joint end is preferably at least partly rounded. The first sealing elements 9 are preferably formed so that they produce the rounding of the first joint end.

The first sealing elements 9 preferably comprise a first sealing ring 11.

The second inner casing 6 of the connecting piece 2 preferably comprises second sealing elements 12 which are adapted to function together with the first inner casing 3 of the duct 1.

In the FIGURE, the second inner casing 6 of the connecting piece 2 comprises a second joint end 13 which is adapted to be pushed partly in the duct 1. The second joint end is preferably at least partly rounded. The second sealing elements 12 are preferably formed so that they produce the rounding of the second joint end.

The second sealing elements 12 preferably comprise a second sealing ring 14.

In the FIGURE, the connecting piece 2 has elements 15 which are adapted to keep the second inner casing 6 and the second outer casing 7 at a distance from each other and to keep the second inner casing 6 and the second outer casing 7 attached to each other.

It is obvious to a person skilled in the art that while technology advances, the basic idea of the invention can be implemented in many different ways. The invention and its embodiments are thus not restricted to the examples described above, but can vary within the scope of the claims.

1. An air-conditioning duct system comprising
ducts (1) which comprise a first inner casing (3) and a first outer casing (4) and a first insulator (5) between them, and
connecting pieces (2) joining the ducts (1), the connecting pieces comprising a second inner casing (6) and a second outer casing (7) and a second insulator (8) between them,
characterized in that
the first insulator (5) in the ducts (1) is an insulating material, and
the second insulator (8) in the connecting piece (2) is insulating air.

2. An air-conditioning duct system as claimed in claim 1, characterized in that the second outer casing (7) of the connecting piece (2) comprises first sealing elements (9) which are adapted to function together with the first outer casing (4) of the duct (1).

3. An air-conditioning duct system as claimed in claim 1, characterized in that the second outer casing (7) of the connecting piece (2) comprises a first joint end (10) which is adapted to be pushed partly into the duct (1 ) and that the first joint end (10) is rounded.

4. An air-conditioning duct system as claimed in claims 2 and 3, characterized in that the first sealing elements (9) produce the rounding of the first joint end (10).

5. An air-conditioning duct system as claimed in any one of claims 1 to 4, characterized in that the first sealing elements (9) comprise a first sealing ring (11).

6. An air-conditioning duct system as claimed in claim 1, characterized in that the second inner casing (6) of the connecting piece (2) comprises second sealing elements (12) which are adapted to function together with the first inner casing (3) of the duct (1).

7. An air-conditioning duct system as claimed in claim 1, characterized in that the second inner casing (6) of the connecting piece (2) comprises a second joint end (13) which is adapted to be pushed partly into the duct (1) and that the second joint end (13) is rounded.

8. An air-conditioning duct system as claimed in claims 6 and 7, characterized in that the second sealing elements (12) produce the rounding of the second joint end (13).

9. An air-conditioning duct system as claimed in any one of claims 6 to 8, characterized in that the second sealing elements (12) comprise a second sealing ring (14).

10. An air-conditioning duct system as claimed in any one of claims 1 to 9, characterized in that the duct (1) is a substantially straight duct.
